(19) United States
(12) Patent Application Publication
(10) Pub. No.: US 2014/0303381 A1
(43) Pub. Date: Oct. 9, 2014

(54) PARTITIONED REACTION VESSELS

(71) Applicant: GE HEALTHCARE LIMITED, BUCKINGHAMSHIRE (GB)

(72) Inventor: Alexander Jackson, Buckinghamshire (GB)

(73) Assignee: GE HEALTHCARE LIMITED, BUCKINGHAMSHIRE (GB)

(21) Appl. No.: 14/346,346

(22) PCT Filed: Oct. 1, 2012
(86) PCT No.: PCT/US12/58212

§ 371 Date: Mar. 21, 2014

Related U.S. Application Data
(60) Provisional application No. 61/541,177, filed on Sep. 30, 2011.

(51) Int. Cl. B01J 19/24; C07B 59/00

(52) U.S. Cl. CPC B01J 19/2475; C07B 59/00
USPC 548/255; 422/149; 564/123; 570/206

(57) ABSTRACT

In view of the needs of the art, the present invention provides a reaction vessel having two distinct compartments, for separating solid-supported reagents. The present invention also provides a method to perform two step radiochemistry procedures in one reactor in a clean and 10 efficient manner. An example of the chemistry that could benefit from this approach is ‘click’ radiochemistry. The present invention provides a method to form the synthon, and react it with an alkyne without the need to perform a purification step.

### FIELD OF THE INVENTION

The present invention relates to the field of multi-step radiochemistry on automated platforms. More specifically, the present invention is directed to a reaction vessel for multi-step chemistry reactions

### BACKGROUND OF THE INVENTION

The challenge of radiolabelling complex and often expensive biomolecules with fluorine-18 has been highlighted by Kuboyama et al (Bioorganic & Medicinal Chemistry 19 (2011) 249-255). There is a need for radiochemical methodology for labeling biomolecules that are present in the smallest amount possible. One possible solution to this goal is to prepare a radiolabelled synthon (e.g. [¹⁸F]fluoroethylazide) and couple this to a biomolecule vector using a fast and high yielding reaction such as the Cu-catalyzed Huisgen ‘click’ reaction. Where the biomolecule is expensive, can only be obtained in small quantities, or where high effective specific activity is required, the radiolabelled synthon must be obtained in a chemically and radiochemically pure form prior to coupling with the biomolecule.

Such a process can be performed in a two-step “one pot” process where the biomolecule is coupled to the radiolabelled synthon in a crude reaction mixture which contains synthon precursor compound. It has been shown that yields of the two-step “one pot” process ‘click labelling’ can be low when the process is done in one reactor. This is partly due to the consumption of the biomolecule (vector-alkyne conjugate) by the unlabelled azide precursor e.g. tosylethylazide. One way around this is to use a two-step process where the labelled fluoroethylazide is purified (by distillation or chromatography) and is coupled to the alkyne in a second step (Glaser, M. & Robins, E. G. ‘Click labelling’ in PET radiochemistry. Journal of Labelled Compounds & Radiopharmaceuticals 52, 407-414 (2009). Glaser, M. et al. Methods for 18F-labeling of RGD peptides: Comparison of aminooxy [¹⁸F]fluorobenzaldehyde condensation with ‘click labeling’ using 2-[¹⁸F]fluoroethylazide, and S-alkylation with [18F]fluoropropanethiol. Amino Acids 37, 717-724 (2009). Glaser, M. & Årstad, E. ‘Click labeling’ with 2-[¹⁸F]fluoroethylazide for Positron Emission Tomography. Bioconj. Chem. 18, 989-993 (2007).). There is therefore a need in the art for a reaction vessel which is partitioned to separate solid-supported reagents to allow the radiolabelling of biomolecules in a single reactor whilst requiring small chemical quantities of the biomolecule.

### SUMMARY OF THE INVENTION

In view of the needs of the art, the present invention provides a reaction vessel having two distinct compartments, for separating solid-supported reagents. The present invention also provides a method to perform two step radiochemistry procedures in one reactor in a clean and efficient manner.

An example of the chemistry that could benefit from this approach is ‘click’ radiochemistry. The present invention provides a method to form the synthon, e.g., [¹⁸F]fluoroethylazide, and react it with an alkyne without the need to perform a purification step. This two-step process might be done in one reactor with minimal formation of by-products by using two solid-supported reagents (one solid-supported radiolabelling precursor and one solid-supported coupling catalyst) that are kept physically separate from each other. This would prevent excess unlabelled azide from reacting with excess alkyne thus keeping the stoichiometry of the coupling reaction favorable. This might enable effective conjugation of fluoroethylazide to alkyne-peptide conjugate using lower levels of peptide than previously used. This would bring the cost of goods down as well as simplifying the radiochemistry process.

An exemplary embodiment is a partitioned reaction vessel for radiochemistry having a chamber including a housing. The housing defines a cavity and further defines an open port in fluid communication with the cavity. The vessel includes a first porous separations media comprising opposed first and second major surfaces, the first major surface being in facing opposition to a first compartment of the cavity. The first compartment is suitable for containing a solid-supported precursor for a radiochemistry method. The second major surface is in facing opposition to a second compartment of the cavity. The second compartment is suitable for containing a solid-supported catalyst for a radiochemistry method. The separations media includes a planar membrane body defining porous passageways extending through said membrane body and opening on the first and second major surfaces. The porous passageways are sized to permit a radioisotope-labelled synthon to pass between said first compartment and said second compartment while maintaining the solid-supported precursor in the first compartment.

Another exemplary embodiment is a cassette for performing a radiochemistry reaction, the cassette having an elongate manifold including first and second end valves and a plurality of interior valves oriented along a manifold flowpath therebetween. The manifold defines an elongate manifold flowpath between each of the valves. The cassette includes a reaction vessel of the present invention, at least one pump means supported on a valve, at least one reagent vial holding contents which are directable into the manifold flowpath, and at least one purification cartridge connected across two of the valves.

Yet another exemplary embodiment is a kit for performing a radiosynthesis method, the kit including an elongate manifold including first and second end valves and a plurality of interior valves oriented along a manifold flowpath therebetween. The manifold defines an elongate manifold flowpath between each of the valves. The kit includes a reaction vessel of the present invention adapted to be connected to one or more of the valves, at least one pump means supported on a valve, at least one reagent vial holding contents which are directable into the manifold flowpath, wherein the reagent vial adapted to be connected to said manifold so that the contents may be directed into the manifold flow path. The kit further includes at least one cartridge adapted to be connected across two of the valves.

Still another exemplary embodiment is a method of performing radiochemistry using a reaction vessel of the present invention. The method includes the steps of:

a) directing an radioisotope into the first compartment;

b) reacting the radioisotope with a solid-supported precursor in the first compartment to obtain a radio-labeled synthon;

c) reacting the radio-labeled synthon with a solid-supported catalyst or coupling reagent and a second reactive molecule in the second compartment to obtain a radio-labeled compound; and

d) directing the radio-labeled compound from the cavity.

Even yet another exemplary embodiment is a method of performing radiochemistry using a reaction vessel of the present invention, where the method includes the steps of:

a) directing an radioisotope into the first compartment;

b) reacting the radioisotope with an solid-supported reagent to generate a reactive form of the radioisotope

c) reacting the reactive form with a solid-supported precursor the second compartment to obtain a radio-labeled compound; and

d) directing the radio-labeled compound from the cavity.

Even still another exemplary embodiment is a method of performing radiochemistry using a reaction vessel of claim 1, including the steps of:

a) directing an radioisotope into the first compartment;

b) reacting the radioisotope with a solid-supported precursor in the first compartment to obtain a radio-labeled synthon;

c) reacting the radio-labeled synthon with a second solid-supported reactive molecule in the second compartment to obtain a radio-labeled compound; and

d) directing the radio-labeled compound from the cavity.

### BRIEF DESCRIPTION OF THE DRAWINGS

FIG. 1 depicts a first partitioned reaction vessel of the present invention, depicting that a solid-supported precursor and a solid-supported catalyst are maintained in separate compartments of the reaction vessel

FIG. 2 depicts the reaction vessel of FIG. 1, and depicts a radioisotope-labelled synthon being able to pass between compartments while maintaining the solid-supported precursor in said first compartment.

FIG. 3 depicts an alternate reaction vessel of the present invention.

FIG. 4 depicts another reaction vessel of the present invention.

FIG. 5 depicts still another reaction vessel of the present invention.

FIG. 6 depicts an automated synthesis cassette incorporating a reaction vessel of the present invention.

FIG. 7 depicts a generic scheme for chemistry suited to the reaction vessel of FIGS. 1-6 where the synthon is coupled to a second precursor compound using a solid-supported catalyst.

FIG. 8 depicts an example of some chemistry that is suited to the reaction vessel of FIGS. 3-6 where the second precursor compound is solid-supported and is cleaved upon reaction with the radiolabelled synthon.

FIG. 9 depicts a general scheme for radioiodination where the precursor is a solid-supported aryl-tin and the oxidant is on a solid support.

### DETAILED DESCRIPTION OF THE PREFERRED EMBODIMENTS

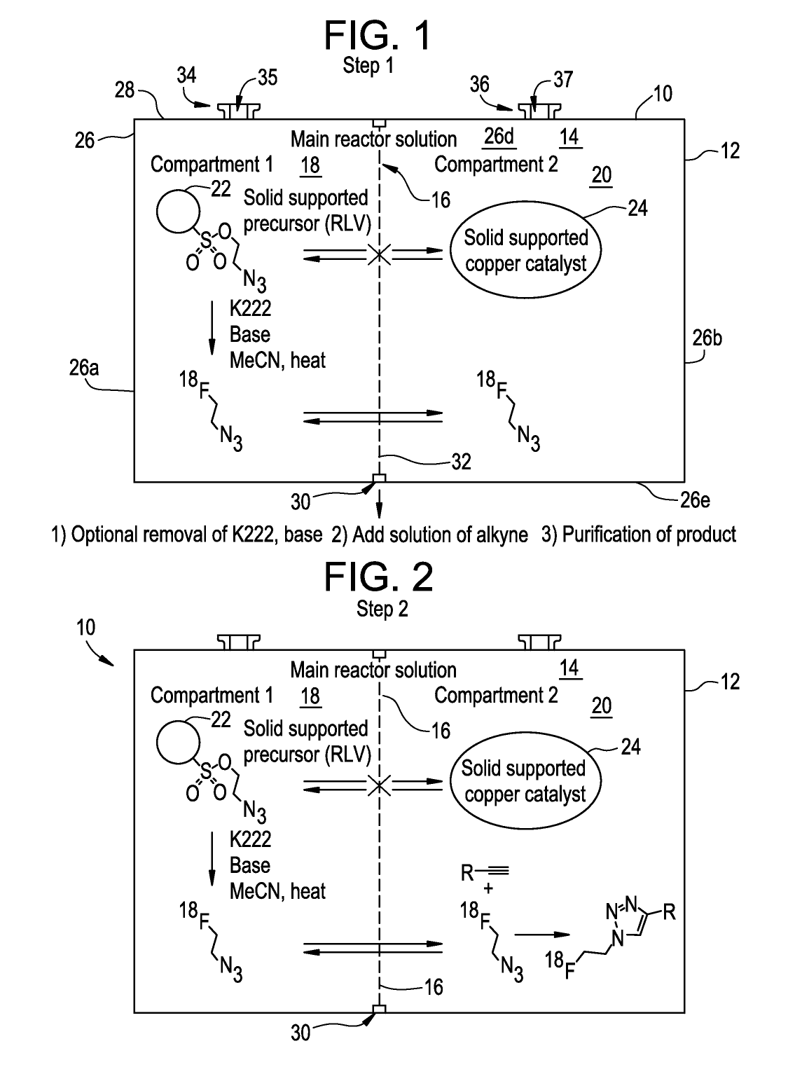

With reference to FIGS. 1 and 2, the present invention is directed to a partitioned reaction vessel and to a method whereby a solid-supported precursor and a solid supported catalyst for the conjugation kept physically separate from each other, and yet still remain in the same reaction solvent. For example, one embodiment of the present invention provides a solid-supported precursor for 2-fluoroethylazide and a solid supported copper catalyst for the conjugation.

The chemical synthesis and radiolabelling of solid-supported precursors have been described previously (Brown et al, Angew. Chem. Int. Ed. 2006, 45, 1-5, EP1648912(B1)). The synthesis of 2-azidoethanol has been described previously (Journal of Organic Chemistry, 70(12), 4746-4750; 2005). Synthesis of a solid-supported precursor for fluoroethylazide by modification of the above methods will be possible for those skilled in the art. A solid supported copper catalyst has been described previously (Steve Ley et al. Org. Biomol. Chem., 2007, 5, 1562-1568. Steve Ley et al. Angew. Chem. Int. Ed. 2009, 48, 4017-4021).

The present invention provides a reaction vessel which includes a porous media for dividing the chamber of the reaction vessel into a first compartment and a second compartment. The present invention contemplates that the porous media may be provided as a single layer media affixed within the chamber so as to divide the chamber into two compartments. Alternatively, the present invention contemplates that the porous media could be provided by a porous media which defines one compartment for the reaction, such as by forming a ‘bag’-like structure from the porous media. Alternatively still, the present invention contemplates that each compartment is defined within a porous-media bag-like structure. The barrier or ‘bag’ structure(s) will allow free diffusion of both the alkyne and the labelled azide. Since a copper catalyst is provided on a solid support, the conjugation reaction can only take place in one compartment in the reactor and therefore the formation of unlabelled triazole conjugate is eliminated.

The platform could be formed from any suitable material such as, by way of illustration and not of limitation, glass carbon or a polymer such as PEEK. The reaction vessel may be used with an automated synthesis system (eg, TRACERlab®, sold by GE Healthcare, Liege, Belgium), or shaped for insertion into a heating well of an automated synthesis system (eg, FASTlab®, sold by GE Healthcare, Liege, Belgium), or may be a manually-operated stand-alone device. The reaction vessel may include an opening of sufficient size to allow the introduction of solid-supported reagents.

This approach could be used in a true ‘one pot’ reaction where all of the reactants are present at the beginning of the reaction. The success of this approach would be dependent on how well the azide-alkyne Huigsen condensation reaction works in the reaction medium used for the fluoridation step. Reaction conditions for this process can be chosen from but not limited to a range of conditions that are known in [¹⁸F]fluoride radiochemistry. These include solutions of Kryptofix 2.2.2, potassium carbonate or bicarbonate, tetra-alkyl ammonium salts, potassium mesylate solution, phosphazine base solutions, potassium tert-butoxide solutions. Some of these examples are known to be suitable for [¹⁸F]fluoride incorporation without the need to have a drying step (WO2010003548(A1), WO2008101305(A1)).

With continued reference to FIGS. 1 and 2, a first reaction vessel 10 of the present invention includes a reaction vessel body 12 defining a reaction chamber 14 and including a porous membrane 16 spanning chamber 14 so as to define first and second reaction compartments 18 and 20, respectively, on either side of membrane 16. First reaction compartment 18 includes a solid-supported precursor 22 therein for a chemical reaction while second reaction compartment 20 includes a solid-supported catalyst 24 therein for a subsequent chemical reaction. Vessel body 12 may include a lower body member 26 and a cap member 28 positioned thereon so as to fully define chamber 14. While body member 26 is shown to include opposing planar surfaces 26a-d and a planar bottom surface 26e and cap member 28 is also planar, the present invention contemplates that vessel 10 may take other shapes (e.g., such as an elongate closed tubular shape).

Membrane 16 is supported by a membrane frame 30 which defines an aperture 32 across which membrane 16 spans. Frame 30 is shaped so as to be coextensive with the interior surfaces of vessel body 12 so that any fluid passing between compartments 18 and 20 must pass through membrane 16. Membrane 16 includes porous passageways therethrough which allow the synthon to pass between first and second compartments 18 and 20, but which will not allow either solid-supported reagent to pass therethrough, thereby maintaining each solid-supported reagent in its respective compartment. Membrane 16 may be formed of any suitably porous material which is able to withstand the thermal and chemical stresses required by the chemical reaction performed using reaction vessel 10. By way of illustration and not of limitation, membrane 16 may be formed from a porous polypropylene membrane.

Vessel body 12 further provides first and second ports 34 and 36 which define apertures 35 and 37 in fluid communication with compartments 18 and 20, respectively. Further embodiments of reaction vessel 10 are described hereinbelow.

In a first step of a two-step chemical reaction, a reaction mixture is formed by passing e.g. Kryptofix 2.2.2, a base, and MeCN (or other eluent composition) through port 34 into the first compartment to mix with the solid-supported precursor (alternatively named a resin-linker-vector or RLV). Heat is applied to chamber 14 to produce a radioisotope-labelled synthon which is able to pass through membrane 16 into second compartment 20.

The next optional step involves purifying the reaction (or cleaning the cartridge). The purifying step may be performed by either:

i) Passing the reaction mixture through a normal phase cartridge to remove e.g. Kryptofix 2.2.2 and potassium carbonate. The reaction solvent which contains [F-18]-fluoroethylazide would be transferred back into chamber 14 and the alkyne is added as shown in FIG. 2; or

ii) Exchanging the reaction solvent for step two of the process by trapping the labelled [F-18]-fluoroethylazide on a reversed phase cartridge and eluting back into the reactor with the new solvent, followed by the addition of the second precursor e.g. an alkyne.

Where either of steps i) and ii) do not take place, the second precursor e.g. the alkyne, may be present in the reaction from the beginning of the process.

After the reaction is complete, high recovery of the labelled materials might be achieved by repeated washing of the reaction vessel and trapping on a reversed phase cartridge prior to purification.

This strategy would require the synthesis of a tosylethylazide Resin-Linker-Vector equivalent. Heterogeneous copper catalysts for the azide-alkyne Huigsen condensation are known (Steve Ley et al. Org. Biomol. Chem., 2007, 5, 1562-1568. Steve Ley et al. Angew. Chem. Int. Ed. 2009, 48, 4017-4021). Prior to the final purification step, excess alkyne might be scavenged by adding a solution phase copper catalyst to the reaction mixture. This would allow the reaction of excess alkyne with the RLV azide leaving theoretically only labelled product and unreacted fluoroethylazide in solution.

In another embodiment, the present invention also contemplates membrane 16 may be omitted from reaction vessel 10 as the provision of a solid-supported precursor and catalyst would offer some advantage since solid-supported reagents are known to have only limited cross reactivity in the same solution. This is due to only a fraction of the available reactive groups being present on the surface of a resin bead.

It will be clear to those skilled in the art that the solid-supported precursor (and therefore the radiolabelled synthon) may have an alkyne functional group instead of an azide functional group. In this case the second precursor compound would have the complementary functional group (azide in this case).

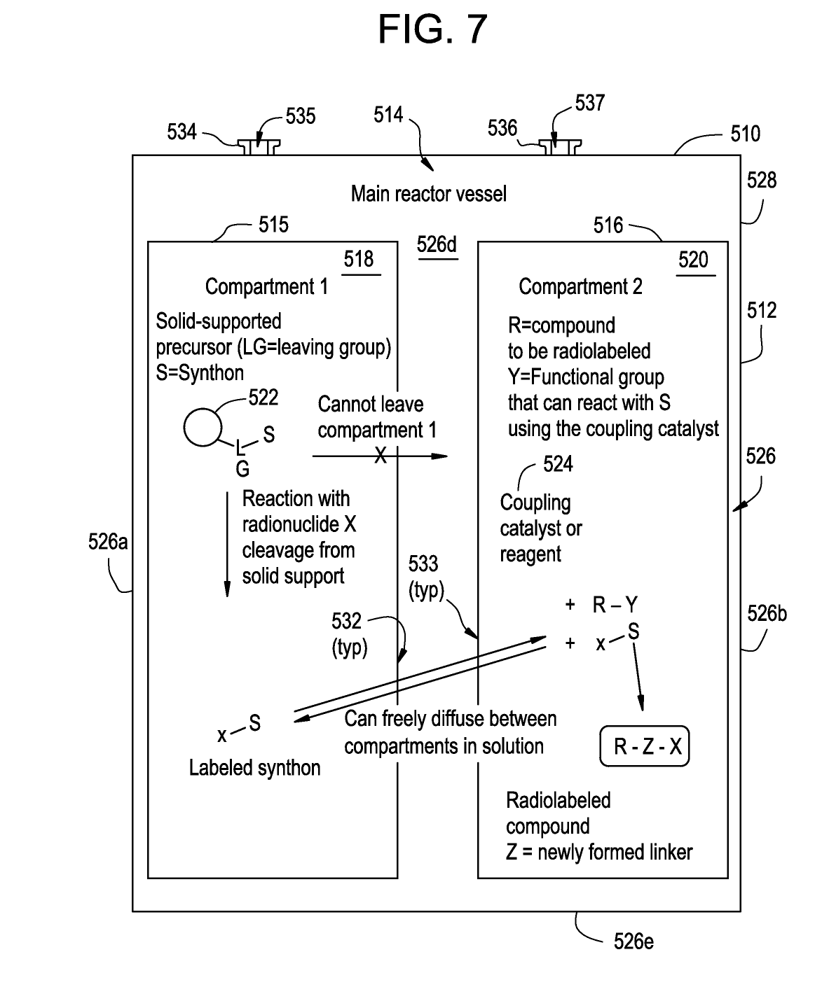

This general approach may also be applicable to any two-step process where an RLV can be used for the synthon precursor, and a solid-supported catalyst or coupling reagent is available for the second step, as shown in FIG. 7.

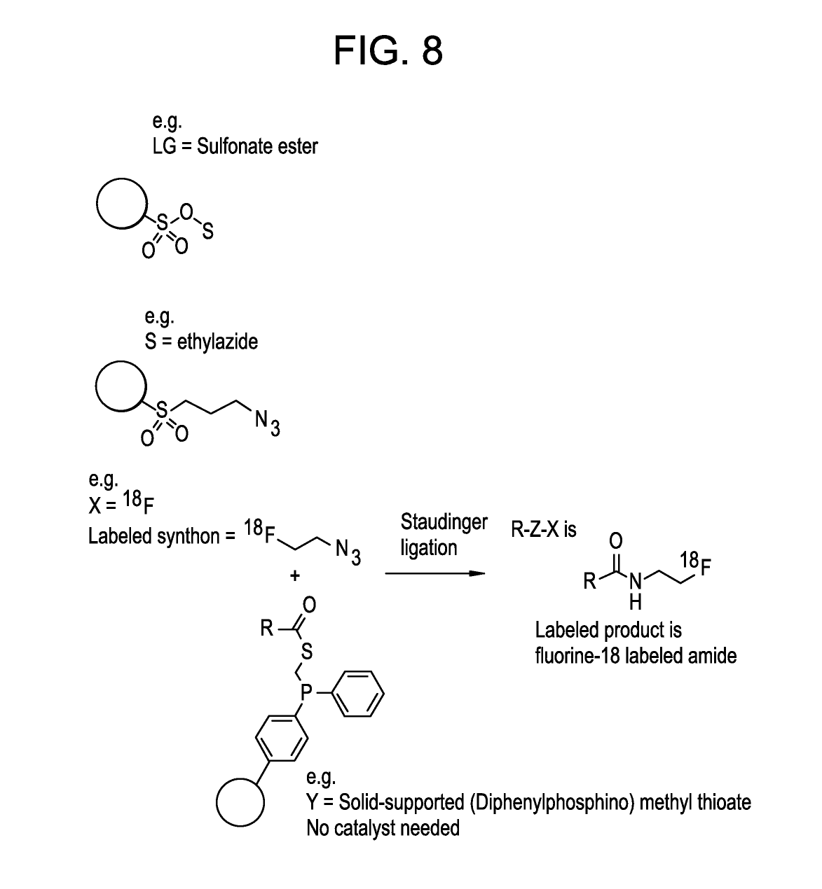

This general approach is also suitable for other chemistries where for example, the synthon is formed by reaction with a solid-supported precursor. The synthon is then able to diffuse into the second reaction compartment where it may react with a second solid-supported precursor, which upon reaction, is released from the solid-support into solution. An example of this is shown in FIG. 8.

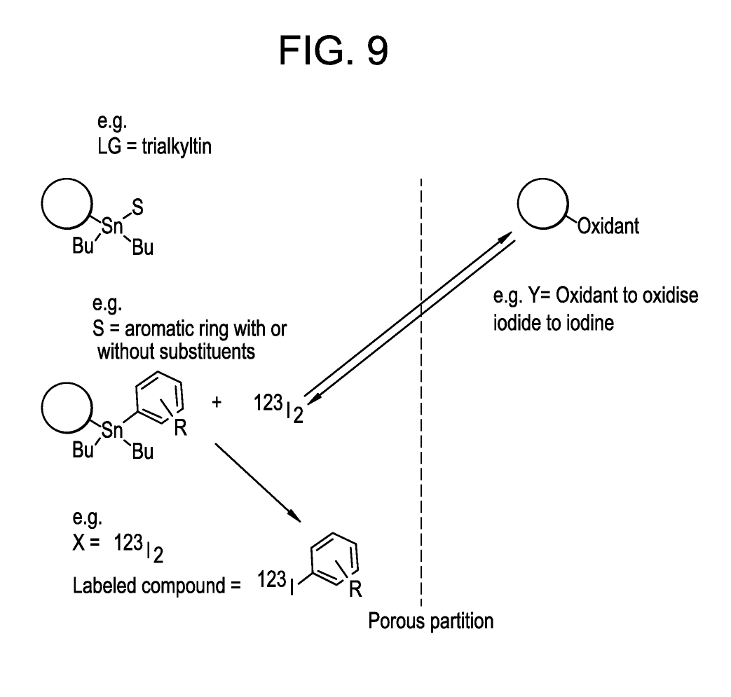

This general approach is also suitable for radiochemistry with other isotopes e.g. radioactive iodine. An example of this chemistry is shown in FIG. 9. The aryl-tin precursor is on a solid-support and the oxidant is also on a solid-support. The radioactive iodide is oxidized to iodine and may diffuse into the first reaction compartment where it may react with the solid-supported aryl-tin precursor releasing the radioiodinated product into solution. An advantage of this approach is that the aryl-tin precursor does not come into contact with the oxidizing agent which may be beneficial when applied to oxidatively sensitive compounds.

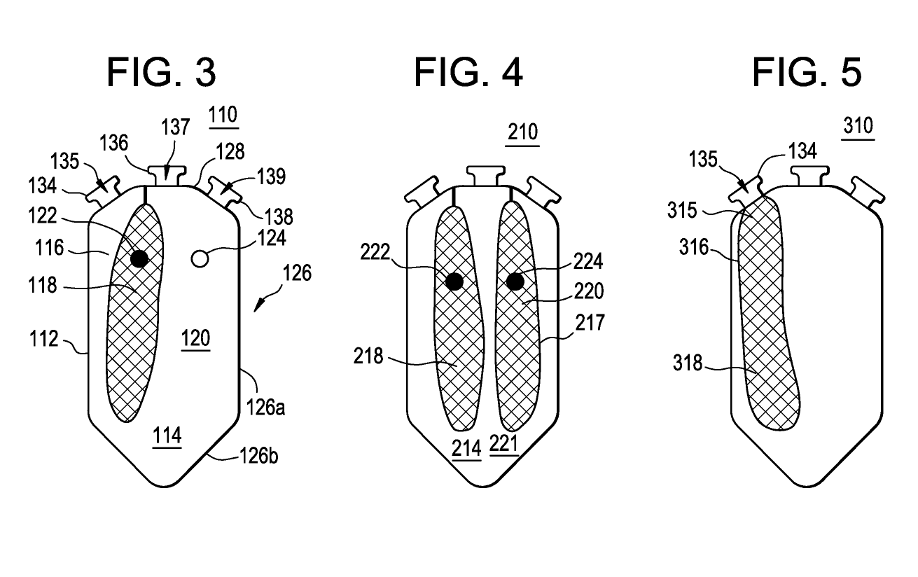

FIG. 3 depicts an alternate reaction vessel 110 of the present invention. Reaction vessel 110 includes an elongate cylindrical vessel body 112 defining a reaction chamber 114 and including a porous membrane bag 116 supported within chamber 114 so as to define a first reaction compartment 118 therein. A second reaction compartment 120 is formed by the portion of chamber 114 not within compartment 120. First reaction compartment 118 includes a solid-supported precursor 122 therein for a chemical reaction while second reaction compartment 120 includes a solid-supported catalyst 124 therein for a subsequent chemical reaction. Vessel body 112 may include a lower body member 126 and a cap member 128 postioned thereon so as to fully define chamber 114. Body member 126 is shown be an elongate cylindrical wall 126a and a tapered closed surface 126b which are sized to fit within the heating well of an automated synthesis device.

Membrane bag 116 is affixed to vessel body 112 at least one point. Membrane bag 116 includes porous passageways therethrough which allow a synthon to pass between first and second compartments 118 and 120, but which will not allow either solid-supported reagent 122 or 124 to pass therethrough, thereby maintaining each solid-supported reagent in its respective compartment. Membrane bag 116 may be formed of any suitably porous material which is able to withstand the thermal and chemical stresses required by the chemical reaction performed using reaction vessel 10. By way of illustration and not of limitation, membrane bag 116 may be formed from a porous polypropylene membrane as is known in solid phase peptide synthesis (Houghton et al 1985, ref. 9) and combinatorial chemistry. Vessel body 112 further provides first, second and third ports 134, 136 and 138 which define apertures 135, 137 and 139 in fluid communication with chamber 114.

FIG. 4 depicts another reaction vessel 210 of the present invention. Reaction vessel 210 is similar to reaction vessel 110 but further includes a second porous bag 217 which defines second compartment 220. In reaction vessel 210, chamber 214 includes a free portion 221 which exists outside of both first and second compartments 218 and 220. Bag 217 is similarly formed from a porous material which permits a synthon to pass therethrough but which maintains physical separation of solid-supported reagents 222 and 224.

FIG. 5 depicts yet another reaction vessel 310 of the present invention. Reaction vessel 310 is similar to reaction vessel 110 but further supports an open end 315 of porous membrane bag 316 about aperture 135 of port 134. By way of illustration and not of limitation, open end 215 of bag 216 may extend through aperture 135 and be affixed to an outer surface of vessel body 112 (or within port 134). For reaction vessel 310, all fluid directed through port 134 will pass through first compartment 318.

FIG. 7 depicts another reaction vessel 510 of the present invention. Reaction vessel 510 includes a reaction vessel body 512 defining a reaction chamber 514 and including first and second porous containers 515 and 516 positioned therein, Porous container 515 defines a first reaction compartment 518 and porous container 516 defines a second reaction compartments 520. Each porous container 515 and 516 is desirably formed from a planar porous membrane sheet 517 and 519 folded back upon itself and sealed at the overlying edges so as to define its compartment 518 and 520, respectively, The present invention contemplates that each porous container is untethered within chamber 514. First reaction compartment 518 includes a solid-supported precursor 522 therein for a chemical reaction while second reaction compartment 520 includes a solid-supported catalyst 524 therein for a subsequent chemical reaction. Vessel body 512 may include a lower body member 526 and a cap member 528 positioned thereon so as to fully define chamber 514. While body member 526 is shown to include opposing planar surfaces 526a-d and a planar bottom surface 526e and cap member 528 is also planar, the present invention contemplates that vessel 510 may take other shapes (e.g., such as an elongate closed tubular shape).

Membranes 517 and 519 define porous passageways 532 and 533 therethrough so that any fluid passing between compartments 518 and 520 must pass through membranes 517 and 519. The porous passageways through membranes 517 and 519 allow the synthon to pass between first and second compartments 18 and 20, but which will not allow either solid-supported reagent to pass therethrough, thereby maintaining each solid-supported reagent in its respective compartment. Membranes 517 and 519 may be formed of any suitably porous material which is able to withstand the thermal and chemical stresses required by the chemical reaction performed using reaction vessel 510. By way of illustration and not of limitation, membranes 517 and 519 may be formed from a porous polypropylene membrane.

Vessel body 512 further provides first and second ports 534 and 536 which define apertures 535 and 537 in fluid communication with chamber 514.

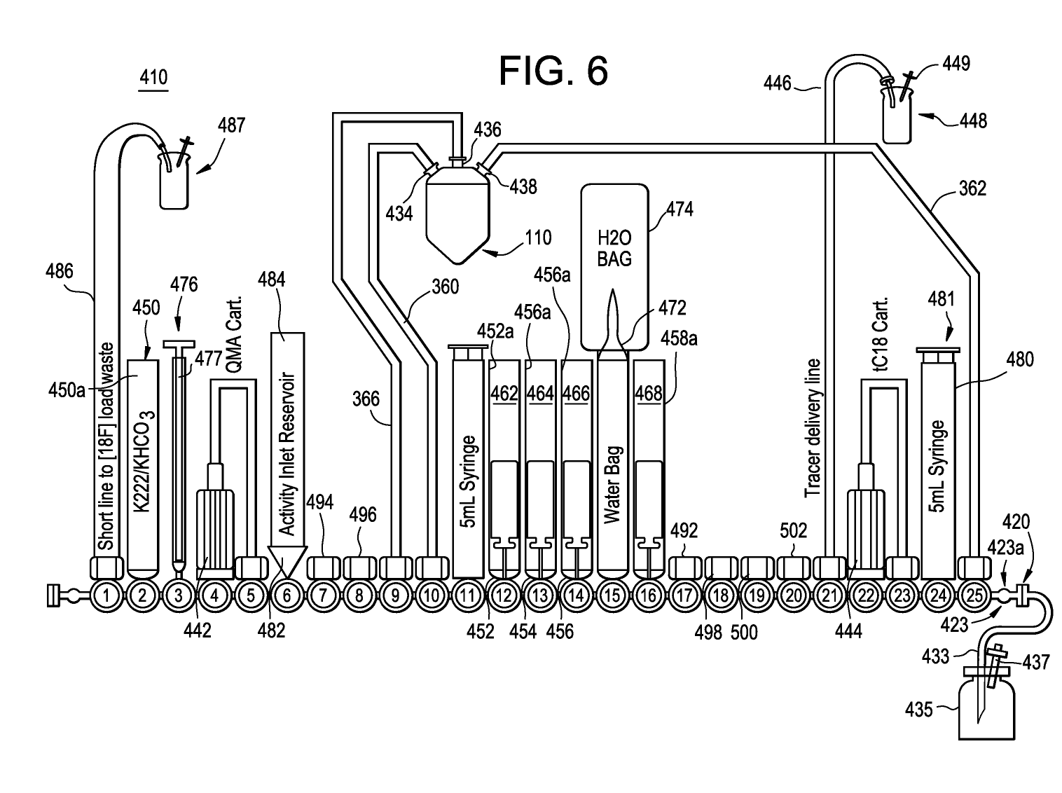

FIG. 6 depicts a cassette 410 incorporating reaction vessel 110 therein. Cassette 410 is designed to be operated by an automated synthesis device such as FASTlab®. Cassette 410 includes a manifold 412

Referring now to FIG. 6, the present invention provides a cassette 410 for performing a multiple-step chemical reaction. Cassette 410 is particularly suitable for performing radiochemistry synthesis methods. Cassette 410 may be formed as a one-use, or disposable, device for synthesizing a compound. Cassette 410 is removably mounted to a synthesis device, such as FASTlab®, so that required connections may be made between cassette 410 and other components, e.g., a source of a radioisotope, dispense vials configured for receiving either product fluid or waste, as well as motive fluid sources.

Cassette 410 desirably includes a polymeric housing (not shown) having a planar major front surface and defining a housing cavity in which an manifold 412 is supported. Cassette 410 includes reactor vessel 110 and vessel ports 134, 136 and 138 are connected in individual fluid communication with valves 10, 9, and 25 via elongate fluid conduits 360, 366, and 362, respectively. Reactor vessel 110 is sized such that vessel body 12 may be placed within a heating cavity of the synthesizer so that heat may be applied to reaction occurring in chamber 114.

A QMA or other suitable cartridge 442 is positioned between manifold positions 4 and 5 while a second separations cartridge 444 is positioned between manifold positions 22 and 23. QMA cartridge 442 is used for capture and release of fluoride at the start of the synthesis. While these solid-phase separations cartridges are shown at these locations, the present invention contemplates that solid-phase extraction cartridges may be arranged depending in the requirements of the labeled compound, at positions 17-20 on the manifold to allow purification and processing. Second separations cartridge 444 is used for solvent exchange, or formulation. A length of Tygon™ tubing 446 is connected between manifold valve 21 and a product collection vial 448 in which is dispensed the formulated drug substance. Vial 448 desirably supports a vent needle 449 so as to allow gas within vial 448 to escape therefrom while the vial fills with the product fluid dispensed from cassette 410. While some of the tubings or conduits of the cassette are, or will be, identified as being made from a specific material, the present invention contemplates that the tubings employed in cassette 410 may be formed from any suitable polymer and may be of any length as required.

With continued reference to FIG. 6, manifold 410 includes upstanding hollow vial housings 450, 452, 454, 456, and 458 at valves 2, 12, 13, 14, and 16 respectively. Vial housings 450, 452, 454, 456, and 458 include a cylindrical wall 450a, 452a, 454a, 456a, and 458a defining vial cavities 460, 462, 464, 466, and 468, respectively, for receiving a vial containing a reagent for the reaction. Each reagent vial reagent container includes a container body defining an open container mouth and a container cavity in fluid communication with the container mouth and a pierceable septum sealing said container mouth. Each septum is pierceable by the spike, or cannula, projecting from the manifold valve supporting its respective reagent housing. The present invention contemplates that each container body is adapted to be held in slideable engagement with the cylindrical wall of its respective reagent housing in a first position spaced from the respective spike and a second position in which said respective spike extends through the septum into the container cavity. In the second position the container cavity will be in fluid communication with a valve port of its respective valve so that the reagent may be drawn into the manifold and directed as needed for the radiosynthesis method.

Cassette 110 desirably includes an elongate hollow support housing 470 having a first end supported at valve 15 and an opposed second end supporting an elongate hollow spike 472 extending therefrom. Spike 472 is designed to pierce the septum of a water container 474 which desirably provides a supply of water-for-injection for use in the synthesis process. Cassette 410 further includes a plurality of pumps engageable by the synthesis device in order to provide a motive force for fluids through the manifold. Valves 3, 11, and 24 each support a syringe pump 476, 478, and 480, respectively, in fluid communication with the upwardly-opening valve port and each including a slideable piston reciprocably movable by the synthesizer device. Syringe pump 476 is desirably a 1 ml syringe pump that includes an elongate piston rod 477 which is reciprocally moveable by the synthesis device to draw and pump fluid through manifold 412 and the attached components.

Valve 6 supports an elongate hollow housing 482 having a cylindrical wall 482a defining an open elongate cavity 484. The radioisotope, for example [¹⁸F]fluoride, is provided in solution with H₂[¹⁸0] target water and is introduced at manifold valve 6. Connection of the source of the radioisotope is made to housing 482 prior to the initiation of synthesis. Valve 1 supports a length of tubing 486 extending to a waste collection vial 487 which collects the waste-enriched water after the fluoride has been removed by the QMA cartridge 442. The fluoride will be eluted from cartridge 442, using a solution chosen from but not limited to Kryptofix 2.2.2, potassium carbonate or bicarbonate, tetra-alkyl ammonium salts, potassium mesylate solution, phosphazine base solutions, potassium tert-butoxide from vial housing 450, and delivered to the reaction vessel 110.

Valves 7, 8, and 17-20 support luer caps 492, 494, and 496, 498, 500 and 502, respectively, thereon in order to seal the upwardly-opening valve port thereof. Syringe pumps 478 and 480 may be a 5 ml syringe pump that includes an elongate piston rod 479 and 481, respectively, which are reciprocally moveable by the synthesis device to draw and pump fluid through manifold 412 and the attached components. Movement of fluid through manifold 412 is additionally coordinated with the positioning of the stopcocks of valves 1-25, the provision of a motive gas at gas ports 421a and 423a as well as by a vacuum, such as that applied to port 420 (possibly through a waste vial 435 connected thereto). The motive gas and the water-for-injection may be pumped through manifold 412 so as to assist in operating cassette 410.

Cassette 410 is mated to an automated synthesizer, such as a FASTlab synthesizer, having rotatable arms which engage each of the stopcocks of valves 1-25 and can position each stopcock in a desired orientation so as to direct fluid flow throughout cassette operation. The synthesizer also includes a pair of spigots, one of each of which insert into ports 421a and 423a of connectors 421 and 423 in fluid-tight connection. The two spigots respectively provide a source of nitrogen and a vacuum to manifold 412 so as to assist in fluid transfer therethrough and to operate cassette 410 in accordance with the present invention. The free ends of the syringe plungers 477, 479, and 481 are engaged by cooperating members from the synthesizer, which can then apply the reciprocating motion thereto within the syringes 475, 478, and 480, respectively. A bottle 474 containing water is fitted to the synthesizer then pressed onto spike 472 to provide access to a fluid for driving compounds under operation of the various-included syringes. Reaction vessel 110 will be placed within the heating well of the synthesizer and the product collection vial 448 and waste vial 487 are connected. The synthesizer includes a radioisotope delivery conduit which extends from a source of the radioisotope, typically either vial or the output line from a cyclotron, to a delivery plunger. The delivery plunger is moveable by the synthesizer from a first raised position allowing the cassette to be attached to the synthesizer, to a second lowered position where the plunger is inserted into the housing 482 at manifold valve 6. The plunger provides sealed engagement with the housing 482 at manifold valve 6 so that the vacuum applied by the synthesizer to manifold 412 will draw the radioisotope through the radioisotope delivery conduit and into manifold 412 for processing. Additionally, prior to beginning the synthesis process, arms from the synthesizer will press the reagent vials onto their respective cannulas at their manifold valves. Lastly, a conduit 433 is connected to port 420 and spans to a waste vial 435 so that the cavity of vial 435 is in fluid communication with port 420. Waste vial 435 is also pierced by a vent needle 437 which allows gas to pass therethrough but not liquid. A conduit 439 extends from vent 437 to a vacuum port (not shown) on the synthesizer. The synthesis process may then commence.

The present invention further contemplates providing cassette 110 as part of a kit which may be assembled so as to perform a radiosynthesis method. The kit desirably provides cassette 410 with the required lengths of tubing as well as the reagents to be placed in the reagent housings. The kit may further provide the reagent containers positioned within the reagent housings at the first position so that their respective septums are spaced from the underlying spikes of their respective valves. The present invention contemplates that the components of cassette 110 may be provided with as many or as few of the components pre-connected as is desired. All of the kit components are adapted to be assembled to form a cassette of the present invention. The kit is desirably shipped and stored in a sterile container, such as a sealed plastic bag or case, the interior of which maintains a clean and sterile environment for the kit components. The kit bag or container may include a tray having molded depressions into which the kit components are held. By loading the kit components into the sterile container in room under clean conditions, sealing of the container will maintain the clean environment within the container for the kit components. The kit is desirably opened in clean environment, for example in either a clean and sterile facility or under a hood providing clean conditions. Assembly of the kit components may then take place in clean conditions as well.

While the particular embodiment of the present invention has been shown and described, it will be obvious to those skilled in the art that changes and modifications may be made without departing from the teachings of the invention. For example, whilst this idea focuses on “click chemistry”, the present invention may be applied to other synthon-based radiochemistry (other synthons and/or other radioisotopes etc). The matter set forth in the foregoing description and accompanying drawings is offered by way of illustration only and not as a limitation. The actual scope of the invention is intended to be defined in the following claims when viewed in their proper perspective based on the prior art.

What is claimed is:

1. A partitioned reaction vessel for radiochemistry comprising:
A chamber comprising a housing , said housing defining a cavity, said housing further defining an open port in fluid communication with said cavity;
A first porous separations media comprising opposed first and second major surfaces, said first major surface being in facing opposition to a first compartment of said cavity, said first compartment being suitable for containing a solid-supported precursor for a radiochemistry method, said second major surface being in facing opposition to a second compartment of said cavity, said second compartment suitable for containing a solid-supported catalyst for a radiochemistry method;
Wherein said separations media comprises a planar membrane body defining porous passageways extending through said membrane body and opening on said first and second major surfaces; and
Wherein said porous passageways are sized to permit a radioisotope-labelled synthon to pass between said first compartment and said second compartment while maintaining said solid-supported precursor in said first compartment.

2. A partitioned reaction vessel of claim 1, wherein said first compartment is defined between said first separations media and a portion of said housing.

3. A partitioned reaction vessel of claim 1, wherein said separations media defines said first compartment.

4. A partitioned reaction vessel of claim 1, further comprising a second separations media comprising a second planar membrane defining porous passageways extending through said membrane body and opening on said first and second major surfaces, wherein said porous passageways are sized to permit a radioisotope-labelled synthon to pass between said first compartment and said second compartment while maintaining said solid-supported precursor in said first compartment, wherein said first compartment is defined between said first and second planar membranes.

5. A partitioned reaction vessel of claim 4, wherein said first planar membrane is joined to said second planar membrane to define said first compartment therebetween.

6. A partitioned reaction vessel of claim 3, wherein said first major surface of said first membrane is joined upon itself to define said first compartment.

7. A partitioned reaction vessel of claim 1, further comprising a second separations media, wherein said second compartment is defined between said second separations media and a portion of said housing.

8. A partitioned reaction vessel of claim 7, wherein said second separations media defines said second compartment.

9. A partitioned reaction vessel of claim 7, further comprising a secondary separations media, wherein said secondary separations media further comprises a planar membrane body comprising opposed first and second major surfaces and defining porous passageways extending through said membrane body and opening on said first and second major surfaces thereof, wherein said porous passageways are sized to permit a radioisotope-labelled synthon to pass therethrough.

10. A partitioned reaction vessel of claim 9, wherein said second planar membrane is joined to said secondary planar membrane to define said second compartment therebetween.

11. (canceled)

12. (canceled)

13. A method of performing radiochemistry using a reaction vessel of claim 1, comprising the steps of:
a) directing an radioisotope into said first compartment;
b) reacting said radioisotope with a solid-supported precursor in said first compartment to obtain a radio-labeled synthon;
c) reacting said radio-labeled synthon with a solid-supported catalyst or coupling reagent and a second reactive molecule in said second compartment to obtain a radio-labeled compound; and
d) directing said radio-labeled compound from said cavity.

14. A method of performing radiochemistry using a reaction vessel of claim 1, comprising the steps of:
a) directing an radioisotope into said first compartment;
b) reacting said radioisotope with an solid-supported reagent to generate a reactive form of the radioisotope
c) reacting said reactive form with a solid-supported precursor said second compartment to obtain a radio-labeled compound; and
d) directing said radio-labeled compound from said cavity.

15. A method of performing radiochemistry using a reaction vessel of claim 1, comprising the steps of:
a) directing an radioisotope into said first compartment;
b) reacting said radioisotope with a solid-supported precursor in said first compartment to obtain a radio-labeled synthon;
c) reacting said radio-labeled synthon with a second solid-supported reactive molecule in said second compartment to obtain a radio-labeled compound; and
d) directing said radio-labeled compound from said cavity.

16. A cassette for performing a radiochemistry reaction, comprising:
An elongate manifold including first and second end valves and a plurality of interior valves oriented along a manifold flowpath therebetween, said manifold defining an elongate manifold flowpath between each of said valves;
a reaction vessel of claim 1;
at least one pump means supported on a valve;
at least one reagent vial holding contents which are directable into said manifold flowpath; and
at least one purification cartridge connected across two of the valves wherein
said end valves including at least two valve ports and a stopcock positionable to place to either place its respective valve ports in fluid communication with each other or to fluidically isolate each of its respective valve ports from each other, wherein one of the at least two valve ports opens exteriorly from its respective end valve;
said plurality of interior valves including three valve ports and a stopcock positionable to place at least two said valve ports in fluid communication with each other, and wherein two of the valve ports for each valve are in fluid communication with a valve port of an adjacent valve and the third valve port opens exteriorly from its respective interior valve, and
wherein each of said valves supports, in fluid communication with its exteriorly-opening valve port, one of a connector, an elongate open vial housing, a syringe pump, and an elongate open inlet housing, each valve supporting a vial housing further supporting an elongate hollow spike extending into the vial housing.

17. (canceled)

18. A cassette of claim 16, wherein said reaction vessel is connected to said manifold at two distinct valves.

19. A cassette of claim 16, further comprising three pump mechanisms each supported on a distinct valve.

20. (canceled)

21. (canceled)

22. A cassette of claim 16, wherein said reaction vessel includes a solid-supported precursor in said first compartment of said reaction vessel and a solid-supported catalyst in said second compartment of said reaction vessel.

23. A kit for performing a radiosynthesis method, said kit including:
An elongate manifold including first and second end valves and a plurality of interior valves oriented along a manifold flowpath therebetween, said manifold defining an elongate manifold flowpath between each of said valves;
a reaction vessel of claim 1 adapted to be connected to one or more of said valves;
at least one pump means supported on a valve;
at least one reagent vial holding contents which are directable into said manifold flowpath, said reagent vial adapted to be connected to said manifold so that said contents may be directed into said manifold flow path; and
at least one cartridge adapted to be connected across two of the valves.

24. A kit of claim 23, wherein said valves further comprise valve stopcocks; and
Wherein said valve stopcocks and said at least one pump means are adapted to be cooperatively operated by a synthesis device to which said manifold is connected.

25. A kit of claim 23 provided in a sealed package comprising a package container defining a cavity, said cavity being in as sterile condition.
